(19) United States
(12) Patent Application Publication
(10) Pub. No.: US 2021/0307419 A1
(43) Pub. Date: Oct. 7, 2021

(54) Adjustable Face Mask

(71) Applicant: Bella + Canvas, LLC, Commerce, CA (US)

(72) Inventors: Daniel Harris, Los Angeles, CA (US); Marco DeGeorge, Los Angeles, CA (US); Tory Lowitz, Los Angeles, CA (US)

(21) Appl. No.: 16/875,853

(22) Filed: May 15, 2020

Related U.S. Application Data
(60) Provisional application No. 63/005,079, filed on Apr. 3, 2020.

(51) Int. Cl. A41D 13/11; A41D 31/14; A41D 31/30; A41D 31/102; A41D 31/12; A62B 23/02; A62B 18/02

(52) U.S. Cl. CPC A41D 13/1161; A41D 31/145; A41D 31/305; A62B 18/025; A41D 31/125; A62B 23/025; A41D 31/102

(57) ABSTRACT

Embodiments disclosed herein are directed to an adjustable face mask including a body formed of one or more panels of material, and includes one or more sets of ear apertures. The face mask can include an outer set of ear apertures disposed further from a central vertical axis and an inner set of ear apertures disposed closer to the central vertical axis. A user can select the set of ear apertures that is most comfortable for insertion of the ears to secure the face mask to the user's face. The adjustable face mask can be formed from a single piece of material without any need for sewing, stitching, or the like. The face mask can further include one or more materials that display one of antimicrobial properties, moisture absorbent properties, moisture wicking properties, or water repellent properties.

### PRIORITY

This application claims the benefit of priority to U.S. Provisional application No. 63/005,079, filed Apr. 3, 2020, which is incorporated by reference in its entirety into this application.

### BACKGROUND

Newly emerging respiratory diseases and pathogens, such as Severe Acute Respiratory Syndrome (“SARS”), Swine Flu (“H1N1”), Middle East Respiratory Syndrome (“MERS”), Bird flu (“H5N1”), and more recently the Coronavirus disease 2019 (“SARS-CoV-2: COVID-19”) are shown to have devastating effects if not contained quickly. In a densely populated and highly mobile society, the causative pathogens can spread rapidly through direct contact, droplet transmission, and the like. When the resulting disease outbreaks occur, there is a sharp increase in demand for personal protective equipment (“PPE”) as the entire affected population seeks to contain the outbreak by mitigating transmission. Meeting the needs of this sudden demand for PPE can leave existing supply chains drained of resources. What is needed therefore is a face mask that can mitigate transmission of such pathogens, can be quickly produced, and can be utilized by a wide variety of users.

### SUMMARY

Briefly summarized, embodiments disclosed herein are directed to an adjustable face mask including a body formed of one or more panels of material and one or more sets of ear apertures. In an embodiment, the face mask includes a first set of ear apertures disposed further from a central vertical axis and a second set of ear apertures disposed closer to the central vertical axis. In use, a user can select a set of ear apertures that is best positioned for the user and insert a portion of the outer ear through an ear aperture of the set of ear apertures to secure the face mask to the users face. Further the face mask can be constructed without requiring any sewing, or similar attachment methods, which allows for increased automation, increased manufacturing speed and efficiency, and associated cost savings.

Disclosed herein is an adjustable face mask including, a body including one or more panels of material, the body having a front surface, a rear surface, a top edge, a right edge, a bottom edge, and a left edge, the body defining a bilateral symmetry extending from a central vertical axis, an outer pair of ear apertures including a left ear aperture disposed proximate the left edge, and a right ear aperture disposed proximate the right edge, and an inner pair of ear apertures including a left ear aperture disposed between the central vertical axis and the left outer ear aperture, and a right ear aperture disposed between the central axis and the right outer ear aperture.

In some embodiments, an ear aperture of the outer pair of ear apertures or the inner pair of ear apertures includes one of a slit, an oval aperture, or a circular aperture, and extends from the front surface to the rear surface. The ear aperture defines a vertical height of between 1.75 in. and 2 in.

In some embodiments, the body defines a substantially elliptical shape and includes a vertical height of between 3 in. and 7 in. and a horizontal width between 10 in. and 14 in. In some embodiments, the body defines a substantially crescent shape and includes a vertical height of between 5 in. and 6 in. and a horizontal width of between 11 in. and 12.5 in.

In some embodiments, the adjustable face mask further includes a nose piece extending from the top edge, and defining a vertical height of between 0.5 in. and 1.5 in. and a horizontal width of between 2.5 in. and 3.5 in.

In some embodiments, an ear aperture of one of the outer pair of ear apertures or the inner pair of ear apertures defines an axis that is angled from a vertical axis between 1° and 90°. The inner pair of ear apertures is disposed vertically lower on the body relative to the outer pair of ear apertures.

In some embodiments, the one or more panels of material includes one of antimicrobial properties, moisture absorbent properties, moisture wicking properties, or water repellent properties. The one or more panels of material includes one of an organic material, a synthetic material, a woven material, a non-woven materials, “Jersey-Knit” style, cotton, cotton blends, wool, wool blends, nylon, polymer, polyester, polyester blend, polyethylene terephthalate (PET), rubber, silicone, elastomer, or a synthetic “fleece” material.

In some embodiments, the one or more panels of material includes a resilient material configured to maintain a shape of the body. The resilient material includes one of silicone or a textile hardener. The body further includes a coating. The coating includes one of antimicrobial properties, moisture absorbent properties, moisture wicking properties, water repellent properties, or textile hardener properties. The body includes a first panel of material defining the front surface and a second panel of material defining the rear surface.

Also disclosed is a method of wearing a face mask including providing a face mask having a body including one or more panels of material, the body having a front surface, a rear surface, a top edge, a right edge, a bottom edge, and a left edge, the body defining a bilateral symmetry extending from a central vertical axis, an outer pair of ear apertures including a left ear aperture disposed proximate the left edge, and a right ear aperture disposed proximate the right edge, and an inner pair of ear apertures including a left ear aperture disposed between the central vertical axis and the left outer ear aperture, and a right ear aperture disposed between the central axis and the right outer ear aperture, guiding a left ear through one of an outer left aperture or an inner left aperture, guiding a right ear through one of an outer right aperture or an inner right aperture, and securing the face mask over a nose and mouth area of a user.

In some embodiments, the method further includes adjusting a top edge across a bridge of a nose of the user and adjusting a bottom edge across a chin of the user. In some embodiments, the method further includes shaping a nose piece across a bridge of a nose of the user, the nose piece extending from a top edge of the body.

Also disclosed is a method of manufacturing a face mask, including, forming a body including one or more panels of material, the body having a front surface, a rear surface, a top edge, a right edge, a bottom edge, and a left edge, the body defining a bilateral symmetry extending from a central vertical axis, creating an outer set of apertures including a left aperture disposed proximate the left edge, and a right aperture disposed proximate the right edge, and creating an inner set of apertures including a left aperture disposed between the central vertical axis and the left outer aperture, and a right aperture disposed between the central axis and the right outer aperture.

In some embodiments, the method includes an aperture of one of the outer set of apertures or the inner set of apertures defines a slit extending vertically between 1.75 in and 2 in.

In some embodiments, the method includes an axis of the slit extends at an angle relative to a vertical axis. The angle of the slit is between 1° and 90° relative to a vertical axis. The body defines a substantially crescent shape and includes a vertical height of between 5 in and 6 in. and a horizontal width of between 11.0 in. and 13 in. The body further includes a nose piece extending from a top edge of the body and defining a vertical height of between 0.5 in. and 1 in. and a horizontal width of between 2.5 in. and 3.5 in.

In some embodiments, the method includes the first material includes one of antimicrobial properties, moisture absorbent properties, moisture wicking properties, or water repellent properties. In some embodiments, the first material includes one of an organic material, a synthetic material, a woven material, a non-woven materials, cotton, wool, nylon, polymer, rubber, silicone, elastomer, or a fleece material. In some embodiments, the face mask is cut from a single piece of material.

### DRAWINGS

A more particular description of the present disclosure will be rendered by reference to specific embodiments thereof that are illustrated in the appended drawings. It is appreciated that these drawings depict only typical embodiments of the invention and are therefore not to be considered limiting of its scope. Example embodiments of the invention will be described and explained with additional specificity and detail through the use of the accompanying drawings in which:

FIG. 1A shows a perspective side view of an adjustable face mask, in accordance with embodiments disclosed herein.

FIG. 1B shows a rear view of an adjustable face mask, in accordance with embodiments disclosed herein.

FIG. 2A shows a perspective side view of an adjustable face mask, in accordance with embodiments disclosed herein.

FIG. 2B shows a rear view of an adjustable face mask, in accordance with embodiments disclosed herein.

FIG. 2C shows close up detail of the adjustable face mask of FIG. 2B, in accordance with embodiments disclosed herein.

FIGS. 3A-3B show exemplary cross sectional views of a body of an adjustable face mask, in accordance with embodiments disclosed herein.

FIGS. 4A-4D show an exemplary method of adjusting an adjustable face mask, in accordance with embodiments disclosed herein.

### DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “top,” “bottom,” “front,” “back,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise. To assist in the description of embodiments described herein, the labels such as “left,” “right,” “top,” “bottom,” “front,” “back,” “horizontal,” “vertical” and the like are described in relation to a user wearing the mask.

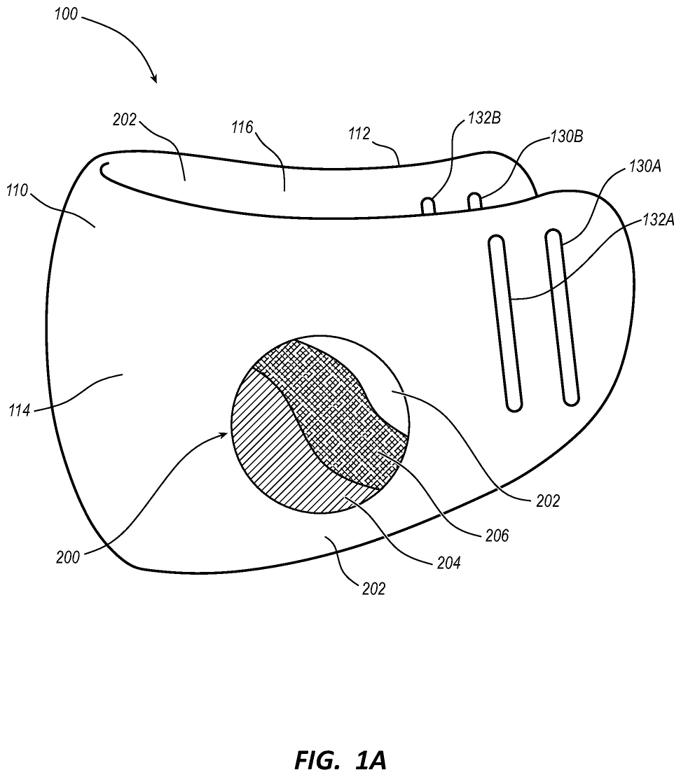

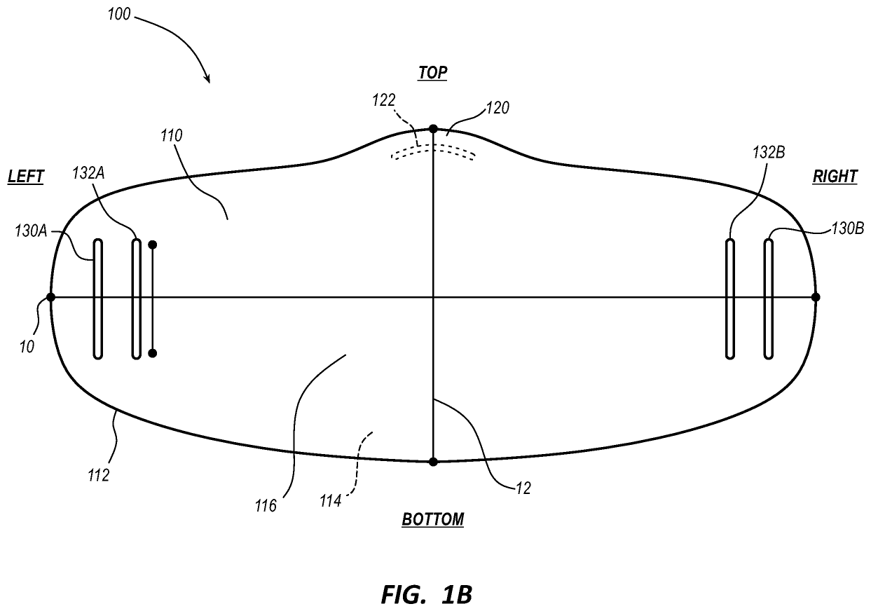

FIGS. 1A-1B show an embodiment of an adjustable face mask (“face mask”) 100, which generally includes a body 110 defining a substantially elliptical outer perimeter 112, a front surface 114 that faces away from the user and a rear surface 116 that contacts a user when the adjustable face mask 100 is worn by the user. The adjustable face mask 100 can further include one or more sets of ear apertures 130, 132, as described in more detail herein.

FIG. 1B shows a rear view of an adjustable face mask 100. In an embodiment, the body 110 extends along a horizontal axis 10 and a vertical axis 12 having a width that is greater than a height of the body 110. In an embodiment the width of the body 110 can be between 10 in. and 14 in. and the height of the body 110 can be between 3 in. and 7 in. In an embodiment the width of the body 110 can be between 11.75 in. and 12.25 in. and the height of the body 110 can be between 5.0 in. and 6.0 in. However, it will be appreciated that greater or lesser dimensions of the adjustable face mask 100 as also contemplated and are considered to fall within the scope of the present invention.

In an embodiment, the body 110 defines a substantially bi-lateral symmetry extending from a central vertical axis, substantially at vertical axis 12. In an embodiment, the body 110 can further include a nose piece 120. The nose piece 120 is disposed on a top edge of the outer perimeter 112, substantially in line with a central axis 12 of the body 110, and can extend upwards from the outer perimeter 112. The nose piece 120 can define a bi-lateral symmetry extending from the central axis 12. In an embodiment, the nose piece 120 defines a convex top perimeter 124 extending from the upper edge of the body 110. A radius of curvature of the convex perimeter 124 can be between 0.5 in. and 2.5 in. In an embodiment the radius of curvature of the convex perimeter 124 can be 0.75 in. In an embodiment, as described in more detail herein, a width of the nose piece 120 can be between 2 in. and 4 in. and a height of the nose piece 120 can be between 0.5 in and 1.5 in. In an embodiment, a width of the nose piece 120 can be 3.0 in and a height of the nose piece 120 can be 0.75 in. In an embodiment the nose piece 120 can include a malleable support 122. For example, the support 122 can be a malleable metallic strip disposed within the body 110 and can be shaped to fit the bridge of a user's nose.

In an embodiment, the face mask 100 can include one or more sets of ear apertures, for example a first, outer set of ear apertures 130 and a second, inner set of ear apertures 132. Each set of ear apertures can include a left ear aperture, e.g. left ear aperture 130A or left ear aperture 132A, disposed proximate a left-most edge of the body 110, and a right ear aperture, e.g. right ear aperture 130B or right ear aperture 132B, disposed proximate a right-most edge of the body 110. In an embodiment, the outer set of ear apertures 130 are disposed further from a central axis 12 of the face mask 100 and the inner set of ear apertures 132 are disposed closer to the central axis. As such, a left ear aperture 132A of the inner set of ear apertures 132 is disposed between the left ear aperture 130A of the outer set of ear apertures 130 and the central axis 12, in a spaced apart relationship. Similarly, a right ear aperture 132B of the inner set of ear apertures 132 is disposed between the right ear aperture 130B of the outer set of ear apertures 130 and the central axis 12, in a spaced apart relationship. It will be appreciated that additional sets of ear apertures are also contemplated and considered to fall within the scope of the present invention.

In an embodiment, an ear aperture of one of the outer pair of ear apertures 130 or the inner pair of ear apertures 132, can include a vertical slit defining an axial length extending between 0.5 in. and 4 in. In an embodiment, the ear aperture extends between 1.75 in. and 2 in. However, it will be appreciated that greater or lesser dimensions of ear aperture are also contemplated and are considered to fall within the scope of the present invention. In an embodiment, the ear apertures 130, 132 define an elongate oval aperture. However, it will be appreciated that other shapes of ear aperture including elliptical, oval, circular, regular or irregular polygonal shapes, combinations thereof, or the like, are also contemplated. In an embodiment, the ear apertures 130, 132 extend equally from a central horizontal axis, substantially at the horizontal axis 10, such that a vertical mid-point of the ear aperture is aligned with a central horizontal axis 10. It will be appreciated that other configurations of ear apertures 130, 132, are also contemplated including off-set configurations along the vertical axis, the horizontal axis, either within or between sets of ear apertures, combinations thereof, or the like.

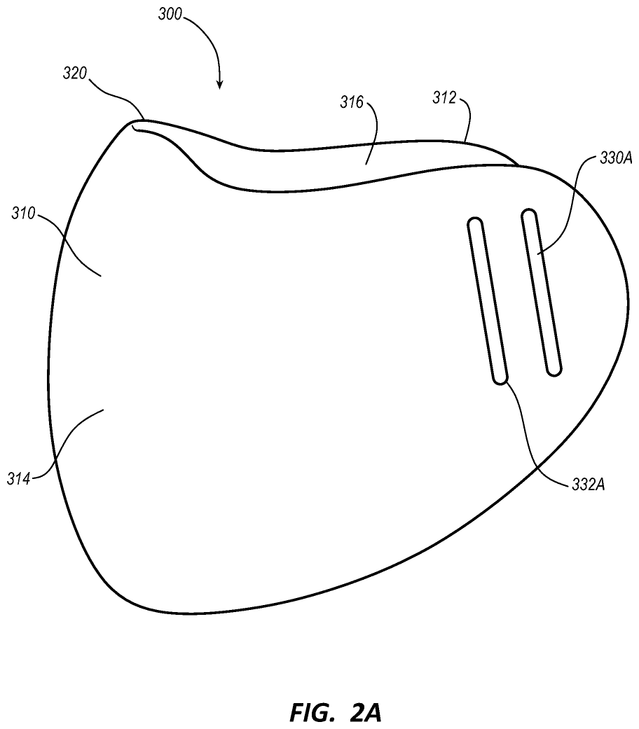

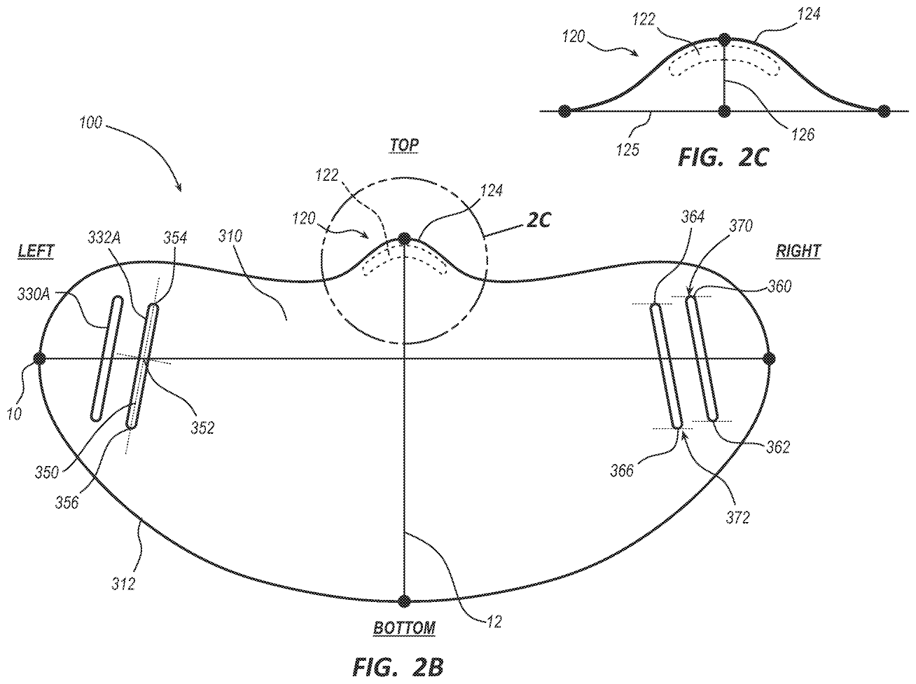

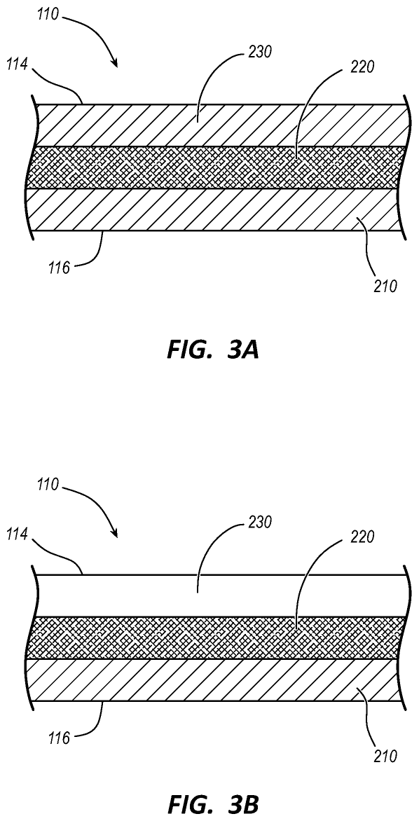

FIGS. 2A-2C show an embodiment of an adjustable face mask 300 that includes a body 310 which can define a substantially crescent shaped, or reniform, outer perimeter 312. The adjustable face mask 300 can further include one or more sets of ear apertures, for example an outer set of ear apertures 330 and an inner set of ear apertures 332. Advantageously, the crescent shaped outer perimeter 312 provides a shape to the body 310 that fits to the users face more comfortably. For example, the crescent shaped body 310 provides a more ergonomic fit to the nose, mouth and cheek region and fits to a user more securely.

FIG. 2B. shows a rear view of an adjustable face mask 300. As shown, the body 310 extends along a horizontal axis 10 and a vertical axis 12 having a width that is greater than a height of the body 310. In an embodiment the width of the body 310 can be between 10 in. and 14 in. and the height of the body can be between 3 in. and 7 in. In an embodiment the width of the body 310 can be between 11.0 in. and 12.0 in. and the height of the body 310 can be between 5.0 in. and 6.0 in. However, it will be appreciated that greater or lesser dimensions of the adjustable face mask 300 as also contemplated and are considered to fall within the scope of the present invention.

In an embodiment, as shown in FIG. 2B, the body 310 defines a substantially bi-lateral symmetry extending from a central vertical axis, substantially at vertical axis 12. In an embodiment, the crescent shaped outer perimeter 312 provides a vertically offset horizontal width where a horizontal axis 10 defining a maximum horizontal width is disposed closer to a top edge than a bottom edge.

As shown in FIGS. 2B-2C, in an embodiment, the body 310 can further include a nose piece 120, as described herein. The nose piece 120 can be disposed on a top edge of the body 310, substantially in line with a central axis 12 of the body 310, and can extend upwards from the outer perimeter 312. The nose piece 120 can define a bi-lateral symmetry extending from the central axis 12. In an embodiment, the width of the nose piece 125 can be between 2.5 in. and 3.5 in. In an embodiment, the width of the nose piece 125 can be 3.0 in. In an embodiment, the nose piece 120 can extend upwards from a top edge of the perimeter 312 between 0.5 in and 1.5 in. In an embodiment, the nose piece 120 can extend upwards from a top edge by 0.75 in. In an embodiment, the upper perimeter 124 of the nose piece 120 defines a convex shape. In an embodiment, a radius of curvature of the convex perimeter 124 can be between 0.5 in. and 2.5 in. In an embodiment the radius of curvature of the convex perimeter 124 can be 0.75 in. In an embodiment, the nose piece 120 can include a malleable support 122, for example, the support 122 can be a malleable metallic strip that can be shaped to fit the bridge of a user's nose.

As shown in FIGS. 2A-2B, in an embodiment, the face mask can include one or more sets of ear apertures, for example, a first outer set of ear apertures 330 and a second, inner set of ear apertures 332. Each set of ear apertures includes a left ear aperture, e.g. ear aperture 330A, disposed proximate a left-most edge of the body 310, and a right ear aperture 330B disposed proximate a right-most edge of the body 310. In an embodiment, the outer set of ear apertures 330 are disposed further from a central axis 12 of the face mask 300 and the inner set of ear apertures 332 are disposed closer to the central axis. As such, a left ear aperture 332A of the inner set of ear apertures 332 is disposed between the left ear aperture 330A of the outer set of ear apertures 330 and the central axis 12, in a spaced apart relationship. Similarly, a right ear aperture 332B of the inner set of ear apertures 332 is disposed between the right ear aperture 330B of the outer set of ear apertures 330 and the central axis 12, in a spaced apart relationship. It will be appreciated that additional sets of ear apertures are also contemplated and considered to fall within the scope of the present invention.

In an embodiment, an ear aperture of either the outer set of ear apertures 330 or the inner set of ear apertures 332, can include a vertical slit extending along an axial length between 0.5 in. and 4 in. In an embodiment, the ear aperture extends 2 in. However, it will be appreciated that greater or lesser dimensions of ear aperture are also contemplated and are considered to fall within the scope of the present invention. In an embodiment, the ear aperture defines an elongate oval aperture. However, it will be appreciated that other shapes of ear aperture are also contemplated.

In an embodiment, each ear aperture of either the outer set of ear apertures 330 or the inner set of ear apertures 332, are aligned along a horizontal axis. In an embodiment, the inner set of ear apertures 332 are disposed lower on the body 310 relative to the outer set of ear apertures 330. It will be appreciated that other configurations of ear apertures 330, 332, are also contemplated including off-set configurations along a vertical axis, a horizontal axis, either within or between sets of ear apertures, combinations thereof, or the like.

In an embodiment, an axis of an ear aperture of either the outer set of ear apertures 330 or the inner set of ear apertures 332 can be angled relative to a vertical axis. For example, an axial length of either left ear aperture 330A of the outer set of ear apertures 330, or a left ear aperture 332A of the inner set of ear apertures 332, can be angled relative to a vertical axis such that a top edge is disposed closer to a central vertical axis 12 that a bottom edge. Similarly, an axial length of either a right ear aperture 330B of the outer set of ear apertures 330, or a right ear aperture 332B of the inner set of ear apertures 332, can be angled relative to a vertical axis such that a top edge is disposed closer to a central vertical axis 12 that a bottom edge. In an embodiment, an axial length of an ear aperture can be angled between 1 and 90 relative to the vertical axis. In an embodiment, the ear apertures can be angled at the same angle. In an embodiment, the ear apertures can be angled at different angles.

Advantageously, the two or more sets of ear apertures 130, 132, 330, 332, allow a user to select the set of apertures that is most comfortable for the ergonomics of the individual, leading to a more secure and more comfortable fit. Worded differently, the face mask 100 can fit securely to a wider variety of different users. For example, an outer set of ear apertures 130 can be configured for adults or for larger individuals, and an inner set of ear apertures 132 can be configured for children or for smaller individuals. As such, a single configuration of face mask 100, 300 can be produced to fit a wide variety of individuals leading to increased efficiencies in manufacturing and distribution, as well as associated costs.

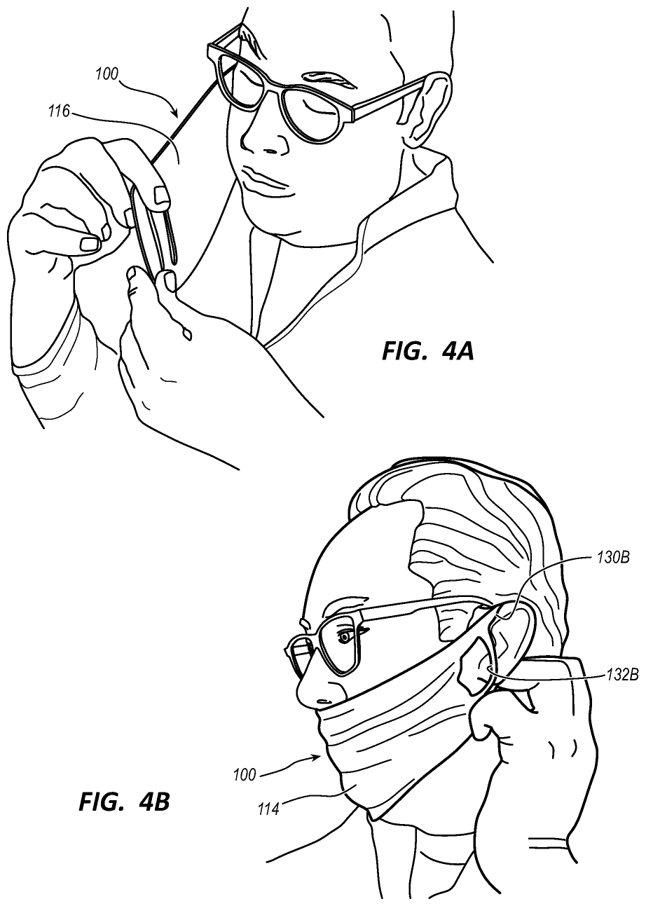

In an embodiment, the body 110 of the face mask 100 can be formed of a single panel of material. In an embodiment, the body 110 can be formed of one or more panels of material assembled together in layers, (e.g. FIG. 3A). For example, a first panel can define a front surface 114 and a second panel can define a rear surface 116. In an embodiment, the body 110 can be formed without sewing or attaching of any kind. Advantageously, forming the body 110 without sewing or attaching of any kind allows for increased automation in the manufacture of the adjustable face mask. This increases the accuracy of the dimensions of the final product, increases the speed of manufacture per unit, and reduces the amount of human contact with the product. As used herein, “attaching” can include joining by stitching, bonding, ultrasonic welding, adhesive, heat activated fusible tape or webbing, or the like, or combinations thereof. In an embodiment, the one or more panels of material can extend over a portion of the body 110.

In an embodiment, as shown in the cut away section 200 of FIG. 1, the face mask 100 can be formed of a single piece of material 202 that is folded such that a first portion forms the front surface 114 and a second portion the rear surface 116. In an embodiment, one or more panels of material, e.g. a first panel 204, and/or a second panel 206, can be disposed within the folded piece of material 202, between the first portion and the second portion.

In an embodiment, the one or more panels of material can be assembled in layers. For example, a first layer 210 can be disposed adjacent a rear surface 116, a second layer 220 can be disposed adjacent a front surface 114. In an embodiment, the first layer 210 can be formed of a first material and a second layer can be formed of a second material. In an embodiment, the first layer 210 and the second layer 220 can be formed of the same material.

In an embodiment, as shown in FIG. 3A, the one or more panels of material can be assembled symmetrically in layers. For example, a first layer 210 consisting of a first material can be disposed adjacent a rear surface 116, a second layer 220 consisting of a second material can be disposed between the first layer 210 and a third layer 230, with the third layer 230 also consisting of the first material disposed adjacent the front surface 114. As such, the one or more panels of material are arranged in layers disposed symmetrically about the second, middle layer 220. It will be appreciated that additional layers, arranged symmetrically with respect to the middle layer 220, are also contemplated. In an embodiment, the body 110 of the face mask can be reversible, such that either a front surface 114 or a rear surface 116 can be positioned against the skin surface of the user.

In an embodiment, the one or more panels of material can be arranged in a specific order. For example, as shown in FIG. 3B, a first layer 210 consisting of a first material can be disposed adjacent a rear surface 116, a second layer 220 consisting of a second material can be disposed between the first layer 210 and a third layer 230, with the third layer 230 consisting of a third material disposed adjacent the front surface 114. It will be appreciated that these and other combinations of layers or materials are also contemplated to fall within the scope of the present invention. In an embodiment, the body 110 of the face mask can be configured to be positioned in a predetermined orientation, for example with a rear surface 116 contacting the skin surface of the user.

In an embodiment the face mask 100 can include various perforations, apertures, vents, valves, or similar structures that affect an airflow through the body 110, between a front surface 114 and a rear surface 116. In an embodiment, one or more of the materials can include water absorbent properties. In an embodiment, one or more of the materials can include moisture absorbent properties. In an embodiment, one or more of the materials can include moisture wicking properties. In an embodiment, one or more of the materials can include moisture repellent properties. In an embodiment, one or more of the materials can include anti-microbial properties. In an embodiment, one or more of the materials can include organic or synthetic, woven or non-woven materials, “Jersey Knit” style materials, such as cotton, cotton blends, wool, wool blends, nylon, polymer, polymer blends, polyester, polyethylene terephthalate (PET), synthetic “fleece” material, rubber, silicone, elastomers, combinations thereof or the like. In an embodiment, one or more of the panels of material can include one or more coatings. The coatings can display water absorbent, water repellent, moisture wicking, anti-microbial, textile hardening properties, combinations thereof, or the like.

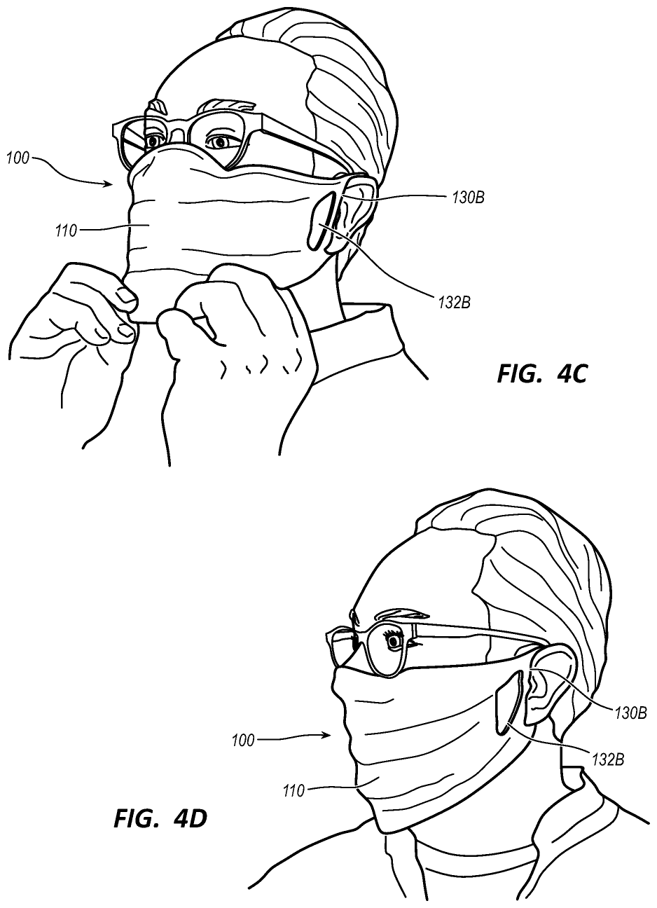

As shown in FIGS. 4A-4D, in an exemplary method of use, an adjustable face mask is provided, e.g. adjustable face mask 100, 300, as described herein. To note, while adjustable face mask 100 is shown, it will be appreciated that this face mask is exemplary and either of adjustable face mask 100 or adjustable face mask 300 can be used in like manner. In an embodiment, a user can position the face mask with a rear surface 116 facing the user and a top edge facing upwards. In an embodiment, the face mask is reversible such that a front surface 114 can be positioned adjacent the user and the rear surface 116 facing outwards. In an embodiment a user selects on of the first set of ear apertures, e.g. ear apertures 130, or a second set of ear apertures, e.g. ear apertures 132, and inserts an outer ear pinna through a first ear aperture of either the first set or second set of ear apertures. For example a left ear through a left ear aperture 130A of an outer set of ear apertures. (FIG. 4A). The user can then insert an outer ear pinna through a second ear aperture of either the first set or second set of ear apertures, for example a right ear through a right ear aperture 130B of an outer set of ear apertures. (FIG. 4B.) In an embodiment, a user can select a left ear aperture of the outer set of ear apertures and a right ear aperture of an inner set of ear apertures, depending on which combination of ear apertures are most comfortable for the user. These and similar combinations of selecting ear apertures are also contemplated to fall within the scope of the present invention. A user can then arrange a top edge of the face mask 100 across a bridge of the nose. (FIG. 4C). In an embodiment, the user can shape the nose piece 120, or optionally the malleable support 122, to fit the bridge of the user's nose. In an embodiment, the user can adjust a bottom edge of the body 110 to fit over the chin of the user, such that the body 110 covers the nose and mouth region of the user. (FIG. 4D.)

Advantageously, the shape and dimensions of the face mask 100, as described herein, are configured to fit comfortably over a user's nose and mouth region. Further, a user can select different ear apertures to suit different shapes or size features of the user, such that the face mask 100 can fit comfortably on users of different sizes or ages.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

1. An adjustable face mask, comprising:
a body including one or more panels of material, the body having a front surface, a rear surface, a top edge, a right edge, a bottom edge, and a left edge, the body defining a bilateral symmetry extending from a central vertical axis and configured for covering a nose or mouth portion of a user;
an outer pair of ear apertures including a left ear aperture disposed proximate the left edge, and a right ear aperture disposed proximate the right edge; and
an inner pair of ear apertures including a left ear aperture disposed between the central vertical axis and the left outer ear aperture, and a right ear aperture disposed between the central vertical axis and the right outer ear aperture,
wherein a top-most edge of the left or right ear aperture of the outer pair of ear apertures or the inner pair of ear apertures is disposed closer to the central vertical axis than a bottom-most edge of the left or right ear aperture.

2. The adjustable face mask according to claim 1, wherein the ear aperture of the outer pair of ear apertures and the inner pair of ear apertures is formed as a slit, and extends from the front surface to the rear surface.

3. The adjustable face mask according to claim 2, wherein the slit defines a vertical height of between 1.75 in. and 2 in.

4. The adjustable face mask according to claim 1, wherein the body defines a substantially elliptical shape and includes a vertical height of between 3 in. and 7 in. and a horizontal width between 10 in. and 14 in.

5. The adjustable face mask according to claim 1, wherein the body defines a substantially crescent shape and includes a vertical height of between 5 in. and 6 in. and a horizontal width of between 11 in. and 12.5 in.

6. The adjustable face mask according to claim 1, further including a nose piece extending from the top edge, and defining a vertical height of between 0.5 in. and 1.5 in. and a horizontal width of between 2.5 in. and 3.5 in.

7. The adjustable face mask according to claim 1, wherein the ear aperture of one of the outer pair of ear apertures or the inner pair of ear apertures defines an axis that is angled from a vertical axis between 1° and 90°.

8. The adjustable face mask according to claim 1, wherein the inner pair of ear apertures is disposed vertically lower on the body relative to the outer pair of ear apertures.

9. The adjustable face mask according to claim 1, wherein the one or more panels of material includes one of antimicrobial properties, moisture absorbent properties, moisture wicking properties, or water repellent properties.

10. The adjustable face mask according to claim 1, wherein the one or more panels of material includes one of an organic material, a synthetic material, a woven material, a non-woven material, a “Jersey-Knit” style material, cotton, cotton-blend, wool, wool-blend, nylon, polymer, polyester, polyester-blend, polyethylene terephthalate (PET), rubber, silicone, elastomer, or a “fleece” material.

11. The adjustable face mask according to claim 1, wherein the one or more panels of material includes a resilient material configured to maintain a shape of the body.

12. The adjustable face mask according to claim 11, wherein the resilient material includes one of silicone or a textile hardener.

13. The adjustable face mask according to claim 1, wherein the body further includes a coating.

14. The adjustable face mask according to claim 13, wherein the coating includes one of antimicrobial properties, moisture absorbent properties, moisture wicking properties, water repellent properties, or textile hardener properties.

15. The adjustable face mask according to claim 1, wherein the body includes a first panel of material defining the front surface and a second panel of material defining the rear surface.

16. A method of wearing a face mask, comprising:
providing a face mask, comprising:
a body including one or more panels of material, the body having a front surface, a rear surface, a top edge, a right edge, a bottom edge, and a left edge, the body defining a bilateral symmetry extending from a central vertical axis;
an outer pair of ear apertures including a left ear aperture disposed proximate the left edge, and a right ear aperture disposed proximate the right edge wherein a top-most edge of the outer pair of ear apertures are disposed closer to the central vertical axis than a bottom-most edge of the outer pair of ear apertures; and
an inner pair of ear apertures including a left ear aperture disposed between the central vertical axis and the left outer ear aperture, and a right ear aperture disposed between the central vertical axis and the right outer ear aperture;
guiding a left ear through one of an outer left aperture or an inner left aperture;
guiding a right ear through one of an outer right aperture or an inner right aperture; and
securing the face mask over a nose and mouth area of a user.

17. The method according to claim 16, further including adjusting the top edge of the body across a bridge of a nose of the user and adjusting the bottom edge of the body across a chin of the user.

18. The method according to claim 16, further includes shaping a nose piece across a bridge of a nose of the user, the nose piece extending from the top edge of the body.

19. A method of manufacturing a face mask, comprising:
forming a body configured for covering a nose or mouth portion of a user including one or more panels of material, the body having a front surface, a rear surface, a top edge, a right edge, a bottom edge, and a left edge, the body defining a bilateral symmetry extending from a central vertical axis;
creating an outer set of apertures including a left aperture disposed proximate the left edge, and a right aperture disposed proximate the right edge; and
creating an inner set of apertures including a left aperture disposed between the central vertical axis and the left outer aperture, and a right aperture disposed between the central vertical axis and the right outer aperture, wherein a top-most edge of the inner set of ear apertures are disposed closer to the central vertical axis than a bottom-most edge of the inner set of ear apertures.

20. The method according to claim 19, wherein an aperture of one of the outer set of apertures or the inner set of apertures defines a slit extending between 1.75 in and 2 in.

21. The method according to claim 20, wherein an axis of the slit extends at an angle relative to the central vertical axis.

22. The method according to claim 21, wherein the angle of the slit is between 1° and 90° relative to the central vertical axis.

23. The method according to claim 19, wherein the body defines a substantially crescent shape and includes a vertical height of between 5 in and 6 in. and a horizontal width of between 11.0 in. and 13 in.

24. The method according to claim 19, wherein the body further includes a nose piece extending from a top edge of the body and defining a vertical height of between 0.5 in. and 1 in. and a horizontal width of between 2.5 in. and 3.5 in.

25. The method according to claim 19, wherein a first material of the one or more panels of material one of antimicrobial properties, moisture absorbent properties, moisture wicking properties, or water repellent properties.

26. The method according to claim 19, wherein a first material of the one or more panels of material includes one of an organic material, a synthetic material, a woven material, a non-woven materials, cotton, wool, nylon, polymer, rubber, silicone, elastomer, or a fleece material.

27. The method according to claim 19, wherein the face mask is cut from a single piece of material.

28. The adjustable face mask according to claim 1, wherein the left or right of the outer pair of ear apertures or the inner pair of ear apertures defines a long axis, and a short axis extending perpendicular thereto, a top edge of the left or right ear apertures of the outer pair of ear apertures or the inner pair of ear apertures that intersects with the long axis is disposed closer to the central vertical axis relative to a bottom edge of the left or right ear apertures of the outer pair of ear apertures or the inner pair of ear apertures that intersects the long axis.

29. The method according to claim 16, wherein the inner pair of ear apertures are disposed vertically lower on the body relative to the outer pair of ear apertures.

30. The method according to claim 20, wherein the inner set of ear apertures are disposed vertically lower on the body relative to the outer set of ear apertures.

31. The adjustable face mask according to claim 1, wherein an inner-most edge of the left or right ear aperture of the outer pair of ear apertures is disposed outward of an outer-most edge of the left or right ear aperture of the inner pair of ear apertures relative to the central vertical axis.

32. The method according to claim 16, wherein an inner-most edge of the left or right ear aperture of the outer pair of ear apertures is disposed outward of an outer-most edge of the left or right ear aperture of the inner pair of ear apertures relative to the central vertical axis.

33. The method according to claim 20, wherein an inner-most edge of the left or right aperture of the outer set of apertures is disposed outward of an outer-most edge of the left or right aperture of the inner set of apertures relative to the central vertical axis.

34. The adjustable face mask according to claim 1, wherein the ear aperture of the outer pair of ear apertures or the inner pair of ear apertures includes an oval aperture and extends from the front surface to the rear surface.
